(19) United States
(12) Patent Application Publication
(10) Pub. No.: US 2021/0113013 A1
(43) Pub. Date: Apr. 22, 2021

(54) Beverage Supply Apparatus

(71) Applicant: SANDEN RETAIL SYSTEMS CORPORATION, Isesaki-shi (JP)

(72) Inventors: Takahiro TORIUMI, Isesaki-shi (JP); Tooru ASAMI, Isesaki-shi (JP); Yuji EBIHARA, Isesaki-shi (JP)

(21) Appl. No.: 16/481,764

(22) PCT Filed: Jan. 12, 2018
(86) PCT No.: PCT/JP2018/001475

§ 371 Date: Jul. 29, 2019

(30) Foreign Application Priority Data
Jan. 30, 2017 (JP) 2017-014627

(51) Int. Cl. A47J 31/46; A47J 31/54; A47J 31/60; A47J 31/40

(52) U.S. Cl. CPC A47J 31/461; A47J 31/469; A47J 31/402; A47J 31/60; A47J 31/542

(57) ABSTRACT

Beverage supply apparatus 100 has tank 3, heating device 6 for heating pipe L31 in milk supply pipe L3 through which a beverage (milk or foamed milk) flows, and first pump 7. When the beverage supply is completed, apparatus 100 fills pipe L3 with water, and enters into a standby state. When the standby state continues for a predetermined time, apparatus 100 discharges the water inside pipe L3 through drain pipe L4, and then again fills pipe L3 with water. Additionally, when a supply instruction is input during the standby state, the beverage supply apparatus 100 discharges the water through the drain pipe L4, discharges the beverage from the drain pipe L4 by a predetermined amount, and then delivers the beverage from the beverage delivery port 10 through the outlet pipe L33.

### TECHNICAL FIELD

The present invention relates to beverage supply apparatuses for supplying beverages.

### BACKGROUND ART

Patent Document 1 discloses a coffeemaker having a pump for sucking milk and carrying milk from a milk container, a coiled tubing through which the milk sucked by the pump flows, a boiler which heats the coiled tubing, and an outlet pipe which is connected to the downstream end of the coiled tubing, wherein the milk sucked by the pump is flowed through the inside of the coiled tubing which is heated by the boiler so that hot (warm) milk can be produced and provided to a cup through the outlet pipe.

Here, it is known that if the inside of piping dries while a trace amount of milk remains inside the heated piping, a milk constituent is precipitated and solidified inside the piping, and the solidified milk constituent attaches to the inner surface of the piping, for example. In particular, if protein in the milk is precipitated and solidified, this can provide nutrients for germs such as microbes to grow inside the piping. Additionally, if the milk constituent is precipitated and solidified, the piping may clog.

With regard to this, when the pump stops after the milk is supplied to the cup, the coffeemaker disclosed in Patent Document 1 fills water inside the coiled tubing and the outlet pipe to prevent the milk constituent from becoming solidified and attached to the coiled tubing and the inner surface of the outlet pipe. Additionally, after the milk is supplied to the cup, the coffeemaker disclosed in Patent Document 1 causes rinse water to flow through the coiled tubing and the outlet pipe to clean the inside of the piping.

### REFERENCE DOCUMENT LIST

### Patent Document

Patent Document 1: JP 2014-208316 A

### SUMMARY OF THE INVENTION

### Problem to be Solved by the Invention

As in the coffeemaker disclosed in Patent Document 1, even if the inside of the coiled tubing and outlet pipe is rinsed and washed after milk is supplied to the cup, it is difficult to completely remove the milk from the inside of the piping. For this reason, to be exact, when the pump stops in the coffeemaker, the inside of the coiled tubing and outlet pipe is filled with a dilute watery milk solution.

Here, the coiled tubing in the coffeemaker disclosed in Patent Document 1 is heated to a high temperature due to heat exchange with boiling water in the boiler, and thus, even if assuming that germs such as microbes are mixed in the dilute watery milk solution, germs such as microbes will not grow inside the high-temperature coiled tubing. However, since the outlet pipe is distant from the boiler, the temperature of the dilute watery milk solution inside the outlet pipe may decrease to a temperature at which germs such as microbes are likely to grow due to nutrients such as proteins and the like. For this reason, the coffeemaker disclosed in Patent Document 1 has room for improvement in terms of sanitation. The same problem also exists in any apparatus that provides beverages other than milk.

While taking the above-described circumstances into account, it is an object of the present invention to provide a beverage supply apparatus having a heating device for heating a beverage, which can supply a high-quality beverage with improved safety and sanitation.

### Means for Solving the Problem

According to one aspect of the present invention, provided is a beverage supplying apparatus comprising a tank for storing a beverage, a heating device for heating an intermediate pipe which constitutes a part of a flow pipe which connects the tank and a beverage delivery port, and a pump which is provided at a predetermined part closer to the tank than the intermediate pipe in the flow pipe, wherein the beverage supply apparatus, when a supply instruction for a hot beverage is input, causes the beverage which is sucked from the tank by driving the pump to flow through the intermediate pipe which is heated by the heating device and through a delivery pipe which constitutes a part of the flow pipe and is connected to an outlet side end part of the intermediate pipe, so as to deliver and supply a predetermined amount of the hot beverage from the beverage delivery port. The beverage supply apparatus, when the supply of the predetermined amount of the hot beverage is complete, fills water inside a predetermined length of piping which at least includes the intermediate pipe and the delivery pipe in the flow pipe, and enters into a standby state. The beverage supply apparatus includes a switching valve which switches a connection destination of the delivery pipe to an outlet pipe or to a drain pipe. When the standby state continues for a predetermined period of time, the beverage supply apparatus discharges the water inside the predetermined length of piping through the drain pipe, and then fills water inside the predetermined length of piping again.

According to another aspect of the present invention, provided is a beverage supplying apparatus comprising a tank for storing a beverage, a heating device for heating an intermediate pipe which constitutes a part of a flow pipe which connects the tank and a beverage delivery port, and a pump which is provided at a predetermined part closer to the tank than the intermediate pipe in the flow pipe, wherein the beverage supply apparatus, when a supply instruction for a hot beverage is input, causes the beverage which is sucked from the tank by driving the pump to flow through the intermediate pipe which is heated by the heating device and through a delivery pipe which constitutes a part of the flow pipe and is connected to an outlet side end part of the intermediate pipe, so as to deliver and supply a predetermined amount of the hot beverage from the beverage delivery port. The beverage supply apparatus, when the supply of the predetermined amount of the hot beverage is complete, fills water inside a predetermined length of piping which at least includes the intermediate pipe and the delivery pipe in the flow pipe, and enters into a standby state. The beverage supply apparatus includes a switching valve which switches a connection destination of the delivery pipe to an outlet pipe or to a drain pipe. The beverage supply apparatus, when the supply instruction is input during the standby state, the beverage supply apparatus discharges the water inside the predetermined length of piping through the drain pipe and then discharges the hot beverage from the drain pipe by a predetermined amount, before delivering the hot beverage from the beverage delivery port through the outlet pipe.

### Effects of the Invention

According to the beverage supply apparatus of the one aspect of the present invention, when the standby state continues for a predetermined time, water inside the predetermined length of piping which includes at least the intermediate pipe which is heated by the heating device, and the delivery pipe in the flow pipe is discharged through the drain pipe, and then, water is filled again in a predetermined length of piping. That is, when the standby state continues for a long time, the water inside the predetermined length of piping is replaced. Therefore, in the standby state, even when the temperature in the delivery pipe reaches a temperature at which germs such as microbes are likely to grow, water inside the predetermined length of piping including the delivery pipe can be replaced at appropriate time intervals, and thus, during the standby state, while preventing a beverage constituent from being precipitated and solidified, and the growth of germs inside the intermediate pipe and the delivery pipe can be prevented.

According to the beverage supply apparatus of another aspect of the present invention, when the supply instruction is input during the standby state, water inside the predetermined length of piping which includes at least the intermediate pipe which is heated by the heating device and the delivery pipe in the flow pipe is discharged through the drain pipe, and the hot beverage is discharged from the drain pipe by a predetermined amount, and then, the hot beverage is delivered from the beverage delivery port through the outlet pipe. That is, when the supply instruction of a beverage is input in a state in which water is filled in the predetermined length of piping including the delivery pipe, the water inside the predetermined length of piping and a first predetermined amount of the beverage are discharged from the drain pipe, and then, the beverage is delivered from the beverage delivery port via the outlet pipe.

For example, when the standby state continues for a long time, germs such as microbes may grow in the water inside the delivery pipe. In this state, even if the supply instruction is input and water inside the predetermined length of piping is discharged from the drain pipe, germs may remain inside the delivery pipe. In this case, as for the beverage which is heated by flowing through the intermediate pipe, a first predetermined amount of beverage which first passes the delivery pipe may be mixed with the remaining germs in the delivery pipe. With regard to this, in the beverage supply apparatus of the another aspect, the first predetermined amount of beverage which first passes the delivery pipe is discharged through the drain pipe, and is not delivered from the beverage delivery port. Thus, according to the beverage supply apparatus of the other aspect, even if the standby state continues for a long time and germs grow in the delivery pipe and the like, the beverage can be supplied without mixing germs in the beverage. Additionally, also in the beverage supply apparatus of the other aspect, water is filled at least in the predetermined length of piping in the standby state, and thus, it is possible to prevent the beverage constituent from being precipitated and solidified.

Thus, a beverage supply apparatus capable of supplying a high-quality beverage by improving safety in sanitation can be provided.

### BRIEF DESCRIPTION OF THE DRAWINGS

FIG. 1 is a block diagram illustrating a schematic configuration of the beverage supply apparatus according to an embodiment of the present invention.

FIG. 2 is a flow line diagram of the beverage supply apparatus.

FIG. 3 is a side view of the heating device of the beverage supply apparatus.

### MODE FOR CARRYING OUT THE INVENTION

[Basic Arrangement of Beverage Supply Apparatus]

Embodiments of the present invention will now be described with reference to the accompanying drawings.

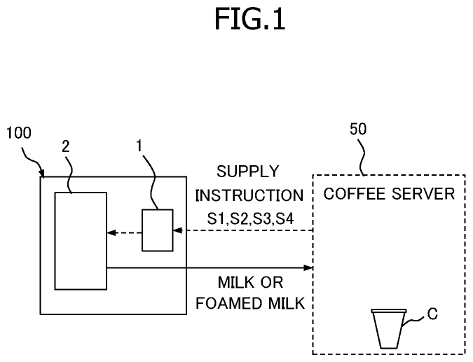

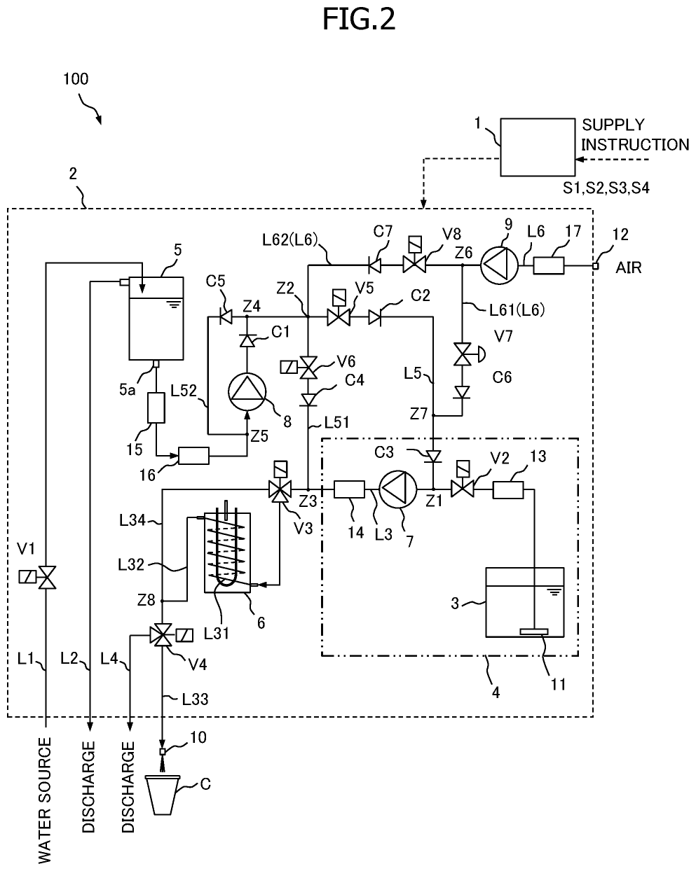

FIG. 1 is the block diagram for explaining the schematic configuration of the beverage supply apparatus 100 of the first embodiment, and FIG. 2 is the flow line diagram of the beverage supply apparatus 100.

As illustrated in FIG. 1, described below is an example of the beverage supply apparatus 100 which is provided adjacent to a coffee server 50 and is used as an optional apparatus of the coffee server 50.

The coffee server 50, for example, brews coffee from coffee powder, and serves the brewed coffee in a cup C. The coffee server 50 can serve preferred coffee by adding liquid milk (hereinafter, simply referred to as “milk”) and foamed milk to the brewed coffee according to the request of the customer or the like.

The beverage supply apparatus 100 is the apparatus which can supply milk or foamed milk in a hot (warm) or cold state, and has the controller 1 and the main body unit 2. In the present embodiment, as described above, the beverage supply apparatus 100 is provided adjacent to the coffee server 50, and supplies the milk or foamed milk inside the cup C which is provided in the coffee server 50.

The controller 1, as illustrated in FIG. 1, controls operation of the main body unit 2, and controls operation of each instrument (a cooling storage 4, a heating device 6, pumps 7 to 9, and valves V1 to V8 described later) to supply the milk or foamed milk in a hot or cold state based on an instruction from the coffee server 50, for example. That is, the beverage supply apparatus 100 controls operation of each instrument to supply the hot milk when the hot milk supply instruction S1 is input to the controller 1, supply the hot foamed milk when the hot foamed milk supply instruction S2 is input to the controller 1, supply the cold milk when the cold milk supply instruction S3 is input to the controller 1, and supply the cold foamed milk when the cold foamed milk supply instruction S4 is input to the controller 1. When none of the supply instructions (S1-S4) is input to the controller 1, the beverage supply apparatus 100 enters into the standby state.

In the present embodiment, the main body unit 2, as illustrated in FIG. 2, includes a milk tank 3, a cooling storage 4, a water tank 5, a heating device 6, a first pump 7, a second pump 8 and a third pump 9.

The milk tank 3 is a tank for storing (holding) the milk. In the present embodiment, the milk tank 3 is accommodated in the cooling storage 4, and is capable of keeping the milk at appropriate low temperature. Additionally, in the present embodiment, the milk tank 3 corresponds to “tank” of the present invention.

The cooling storage 4 at least accommodates the milk tank 3, and is capable of retaining the internal temperature at the appropriate low-temperature set temperature. In the present embodiment, in addition to the milk tank 3, each instrument such as the first pump 7 is disposed in the cooling storage 4. The internal temperature in the cooling storage 4 is controlled to be in the range of 2 to 3° C., for example.

The water tank 5 is a tank for storing water. The water from the water source is supplied to the water tank 5 through a water supply pipe L1 which is opened and closed by the electromagnetic first on-off valve V1, for example. Additionally, the overflow water from the water tank 5 can be discharged through the overflow pipe L2.

The heating device 6 is the device for heating the milk or foamed milk, and heats the heating pipe L31 which constitutes a part of the milk supply pipe L3 which connects the milk tank 3 and the beverage delivery port 10. In the present embodiment, the milk supply pipe L3 corresponds to “flow pipe” of the present invention, and the heating pipe L31 corresponds to “intermediate pipe” of the present invention.

In the present embodiment, the heating device 6 heats the heating pipe L31 so that the heating pipe L31 maintains a predetermined heating set temperature in the state in which any of the supply instructions (S1-S4) of the beverage (the milk or foamed milk) is input from the coffee server 50 and in the standby state in which none of the supply instructions (S1-S4) is input to the controller 1. To be specific, in the state in which the beverage supply apparatus 100 is activated (main power ON), the heating device 6 is kept activated (that is, electricity is supplied to the electric heater 6b described later).

Additionally, in the present embodiment, the heating set temperature of the heating device 6 in the standby state is set higher than the heating set temperature of the heating device 6 in the state in which the supply instruction (S1 or S2) of hot beverage is input. The heating set temperature in the standby state is set to about 80° C., for example, and the heating set temperature in the state in which the supply instruction (S1 or S2) is input is set to about 75° C. Accordingly, when the supply instruction (S1 or S2) is input, the controller 1 controls the heating operation of the heating device 6 to lower the heating set temperature of the heating device 6 from 80° C. to 75° C.

In the present embodiment, the milk supply pipe L3 is the piping for connecting the strainer 11 which is disposed in the milk tank 3 and the beverage delivery port 10, and the milk and foamed milk mainly flow through the milk supply pipe L3. The milk supply pipe L3 includes, for example, an inflow pipe L30, the heating pipe L31, a delivery pipe L32, an outlet pipe L33, and a bypass pipe L34.

The inflow pipe L30 constitutes a part of the milk supply pipe L3, and is disposed upstream of the heating device 6. Specifically, one end of the inflow pipe L30 is connected to a first switching valve V3 described later, and the other end is connected to an inlet side end part L31b of the heating pipe L31 described later. The heating pipe L31 constitutes a part of the milk supply pipe L3, and is provided in the heating device 6 as described in detail later. The delivery pipe L32 constitutes a part of the milk supply pipe L3, and is disposed downstream of the heating device 6. Specifically, one end of the delivery pipe L32 is connected to the outlet side end part L31a of the heating pipe L31, and the other end is connected to the second switching valve V4 described later. The outlet pipe L33 constitutes a part of the milk supply pipe L3, and connects the outlet side end part (in FIG. 2, the part to which the second switching valve V4 described later is connected) of the delivery pipe L32 and the beverage delivery port 10. The bypass pipe L34 constitutes a part of the milk supply pipe L3, and is provided to bypass the heating pipe L31. Additionally, the drain pipe L4 is connected to the outlet side end part of the delivery pipe L32. Additionally, the portions other than the heating pipe L31 in the milk supply pipe L3 are constituted by a silicone hose or a fluorine hose, for example. On the other hand, the heating pipe L31 is constituted by spirally wound stainless steel piping. The beverage delivery port 10 is, for example, a nozzle unit from which the milk or foamed milk is delivered, and is disposed above the cup C.

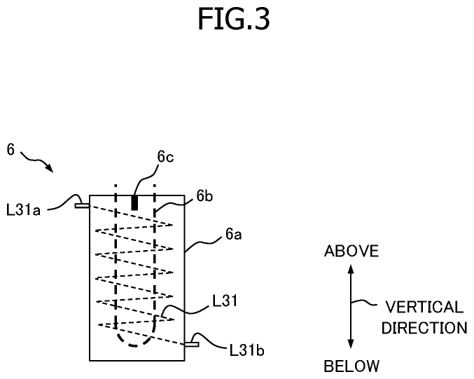

FIG. 3 is a side view of the heating device 6. To be specific, as illustrated in FIG. 3, the heating device 6 includes, for example, a main body 6a constituted by the rectangular parallelepiped aluminum block casting, a U-shaped electric heater 6b cast in the main body 6a, and a temperature measurement sensor 6c inserted into the hole provided in the upper side part of the main body 6a.

The heating pipe L31 and the electric heater 6b are cast in the main body 6a. The outlet side end part L31a of the heating pipe L31 protrudes outward from a predetermined part located above in the vertical direction in one side of the main body 6a, and the inlet side end part L31b of the heating pipe L31 protrudes outward from a predetermined part located below in the vertical direction in the side opposite to the one side of the main body 6a.

The temperature in the main body 6a is measured by the temperature measurement sensor 6c, and is input in the controller 1, for example. The controller 1 controls the input current of the electric heater 6b or the like based on the measured temperature from the temperature measurement sensor 6c to control the temperature in the main body 6a to be maintained at a predetermined heating set temperature. When the main body 6a is heated by the electric heater 6b, the heating pipe L31 cast in the main body 6a is also heated. In the state in which the heating pipe L31 is heated, the milk or the like is made to flow in the inlet side end part L31b, and is made to flow through spirally upward in the main body 6a along the heating pipe L31 so that the milk or the like can be heated up. Then, the heated milk or the like flows out from the outlet side end part L31a of the heating pipe L31. When the cold milk or cold foamed milk is flowed through the inside of the heating pipe L31 in the state in which the heating set temperature of the heating device 6 is set to approximately 75° C., the hot milk or hot foamed milk which is heated to the temperature adequate for drinking flows out from the outlet side end part L31a.

The first pump 7 is the pump that mainly sucks and delivers the milk from the milk tank 3. The first pump 7 is provided at a predetermined part closer to the milk tank 3 than the heating pipe L31 in the milk supply pipe L3. Specifically, the first pump 7 is provided upstream of the branch part (in FIG. 2, the first switching valve V3 described later) to the bypass pipe L34 in the milk supply pipe L3 and at a predetermined part of the milk supply pipe L3 in the cooling storage 4. In the present embodiment, the first pump 7 corresponds to “pump” of the present invention.

The second pump 8 is the pump that sucks and delivers the water from the water tank 5, and is provided on the water supply pipe L5. The second pump 8 is the pump for supplying the water to be filled in the milk supply pipe L3 in the standby state of the beverage supply apparatus 100, and the water (rinse water) for rinsing and cleaning the inside of the milk supply pipe L3 after supplying the milk and foamed milk.

One end of the water supply pipe L5 is connected to the outlet part 5a provided at the bottom of the water tank 5, and the other end is connected to the predetermined part between the first pump 7 and the strainer 11 in the milk supply pipe L3 (hereinafter, referred to as the connecting part Z1).

Additionally, in the present embodiment, a bypass pipe L51 which is branched from the predetermined part downstream (the connecting part Z1 side) of the second pump 8 in the water supply pipe L5 (hereinafter, referred to as the connecting part Z2) is provided. One end of the bypass pipe L51 is connected to the connecting part Z2, and the other end is connected to the predetermined part between the first pump 7 and the branch part (in FIG. 2, the first switching valve V3 described later) of the inflow pipe L30 and the bypass pipe L34 in the milk supply pipe L3 (hereinafter, referred to as the connecting part Z3). When the inside of the milk supply pipe L3 is rinsed including the portion in the cooling storage 4 of the milk supply pipe L3 (that is, the internal piping), the water is supplied into the milk supply pipe L3 via the connecting part Z1. Additionally, when the portion outside the cooling storage 4 of the milk supply pipe L3 (that is, the external piping) is rinsed, the water is supplied into the milk supply pipe L3 via the bypass pipe L51 and the connecting part Z3.

Additionally, in the present embodiment, the water supply pipe L5 is provided with a return pipe L52 to bypass the second pump 8. One end of the return pipe L52 is connected to the predetermined part between the connecting part Z2 and the second pump 8 (hereinafter, referred to as the connecting part Z4), and the other end is connected to the predetermined part between the second pump 8 and the outlet part 5a of the water tank 5 (hereinafter, referred to as the connecting part Z5).

The third pump 9 is the air pump that sucks and delivers air, and is the pump for supplying the air for foamed milk generation and the air purge in the milk supply pipe L3, for example. The third pump 9 is provided on the air supply pipe L6. The air supply pipe L6 is connected to the air intake 12 in which one end is open to the outside. The air supply pipe L6 is branched into the first air supply pipe L61 and the second air supply pipe L62 from the branch part Z6 downstream of the third pump 9. One end of the first air supply pipe L61 is connected to the branch part Z6, and the other end is connected to the predetermined part between the connecting part Z1 and the connecting part Z2 in the water supply pipe L5 (hereinafter, referred to as connecting part Z7). One end of the second air supply pipe L62 is connected to the branch part Z6, and the other end is connected to the connecting part Z2 in the water supply pipe L5. The air for producing the foamed milk mainly flows through the first air supply pipe L61, and the air for the air purge flows through the second air supply pipe L62.

Next, each instrument provided in the milk supply pipe L3, the water supply pipe L5, the bypass pipe L51, the return pipe L52, and the air supply pipe L6 will be described in detail.

The milk supply pipe L3 is provided with the strainer 11, the milk flowmeter 13, the second on-off valve V2, the first pump 7, the expansion part 14, the first switching valve V3, the heating device 6 and the second switching valve V4 in order from the milk tank 3 side to the beverage delivery port 10. The connecting part Z1 is positioned between the second on-off valve V2 and the first pump 7, and the connecting part Z3 is positioned between the expansion part 14 and the first switching valve V3.

The milk flowmeter 13 is, for example, the propeller-rotation-type flowmeter, and outputs a pulse signal to the controller 1 at each rotation. The controller 1 can monitor the milk delivery volume by the first pump 7 based on the number of times of the pulse signal.

The second on-off valve V2 is the valve for opening and closing the milk supply pipe L3, and is constituted by, for example, the electromagnetic pinch valve which is closed (NC) in the initial state (OFF).

The first switching valve V3 is the valve for selectively switching the flow path of milk or the like in the milk supply pipe L3 between the flow path via the heating pipe L31 and the flow path via the bypass pipe L34, and is constituted by, for example, an electromagnetic three-way valve. The first switching valve V3 is operated, for example, to establish communication between the connecting part Z3 and the bypass pipe L34 and to block communication between the connecting part Z3 and the heating pipe L31 (specifically, the inflow pipe L30) in the initial state (OFF), and to block communication between the connecting part Z3 and the bypass pipe L34 and to establish communication between the connecting part Z3 and the heating pipe L31 (specifically, the inflow pipe L30) in the energization state (ON).

The second switching valve V4 is the valve for selectively switching the delivery destination of the milk or the like which flows through the milk supply pipe L3 to the beverage delivery port 10 (outlet pipe L33) and to the drain pipe L4, and is constituted by, for example, the electromagnetic three-way valve. That is, the second switching valve V4 is the valve for selectively switching the connection destination of the delivery pipe L32 to the outlet pipe L33 connected to the beverage delivery port 10 and to the drain pipe L4. The second switching valve V4 is operated, for example, to establish communication between the delivery pipe L32 and the drain pipe L4 and to block communication between the delivery pipe L32 and the outlet pipe L33 in the initial state (OFF), and to block communication between the delivery pipe L32 and the drain pipe L4 and to establish communication between the delivery pipe L32 and the outlet pipe L33 in the energization state (ON). In the present embodiment, the second switching valve V4 corresponds to “switching valve” of the present invention.

The water supply pipe L5 is provided with the strainer 15, a water flowmeter 16, the second pump 8, a first check valve C1, a third on-off valve V5, a second check valve C2 and a third check valve C3 in order from the outlet part 5a side of the water tank 5 to the connecting part Z1. The connecting part Z2 is positioned in the predetermined part between the first check valve C1 and the third on-off valve V5, the connecting part Z4 is positioned between the first check valve C1 and the connecting part Z2, the connecting part Z5 is positioned between the water flowmeter 16 and the second pump 8, and the connecting part Z7 is positioned between the second check valve C2 and the third check valve C3.

Similar to the milk flowmeter 13, the water flowmeter 16 is, for example, the propeller-rotation-type flowmeter, and outputs a pulse signal to the controller 1 at each rotation. The controller 1 can monitor the water delivery volume by the second pump 8 based on the number of times of the pulse signal.

The third on-off valve V5 is the valve for opening and closing the water supply pipe L5, and is constituted by, for example, the electromagnetic pinch valve which is closed (NC) in the initial state (OFF).

The first check valve C1, the second check valve C2, and the third check valve C3 respectively allow flow from the outlet part 5a to the connecting part Z1, and blocks flow from the connecting part Z1 to the outlet part 5a. The opening pressure of each check valve (C1, C2, C3) is set to open promptly after the second pump 8 is activated.

The bypass pipe L51 is provided with a fourth on-off valve V6 and a fourth check valve C4 in order from the connecting part Z2 to the connecting part Z3.

The fourth on-off valve V6 is the valve for opening and closing the bypass pipe L51, and is constituted by, for example, the electromagnetic pinch valve which is closed (NC) in the initial state (OFF).

The fourth check valve C4 allows flow from the connecting part Z2 to the connecting part Z3, and blocks flow from the connecting part Z3 to the connecting part Z2. The set value of the opening pressure of the fourth check valve C4 is the same as the set value of the opening pressure of each check valve (C1 to C3) provided in the water supply pipe L5.

The return pipe L52 is provided with a fifth check valve C5 which allows flow from the connecting part Z4 to the connecting part Z5, and blocks flow from the connecting part Z5 to the connecting part Z4. The opening pressure of the fifth check valve C5 is set to be higher than the pressure generated during the normal operation of the second pump 8. That is, the set value of the opening pressure of the fifth check valve C5 is higher than the set value of the opening pressure of each check valve (C1 to C4) provided in the water supply pipe L5 and the bypass pipe L51. When the abnormality occurs downstream of the second pump 8, the fifth check valve C5 is open, and is capable of looping water through the return pipe L52.

The part between the air intake 12 and the branch part Z6 in the air supply pipe L6 is provided with the strainer 17 and the third pump 9 in order from the air intake 12 side to the branch part Z6. Additionally, the first air supply pipe L61 of the air supply pipe L6 is provided with the flow rate-regulating valve V7, and the sixth check valve C6 in order from the branch part Z6 to the connecting part Z7. The second air supply pipe L62 of the air supply pipe L6 is provided with the fifth on-off valve V8 and the seventh check valve C7 in order from the branch part Z6 to the connecting part Z2.

The flow rate-regulating valve V7 is, for example, the control valve capable of continuously adjusting the opening degree based on, for example, an appropriate input signal. The flow rate-regulating valve V7, for example, based on the signal output from the controller 1, continuously adjusts the valve opening degree from the fully closed state to the fully open state, and is capable of adjusting the flow rate of the air which flows through the air supply pipe L6.

The fifth on-off valve V8 is the valve for opening and closing the second air supply pipe L62, and is constituted by, for example, the electromagnetic pinch valve which is closed (NC) in the initial state (OFF).

The sixth check valve C6 allows flow from the branch part Z6 to the connecting part Z7, and blocks flow from the connecting part Z7 to the branch part Z6. The seventh check valve C7 allows the flow from the branch part Z6 to the connecting part Z2, and blocks the flow from the connecting part Z2 to the branch part Z6. The set value of the opening pressure of the sixth check valve C6 and seventh check valve C7 is the same as the set value of the opening pressure of each check valve (C1 to C4) provided in the water supply pipe L5 and the bypass pipe L51, and is set to open as soon as the third pump 9 is activated.

Additionally, in the present embodiment, by supplying air from a predetermined part between the first pump 7 and the milk tank 3 in the milk supply pipe L3 to the inside of the milk supply pipe L3, and by driving the first pump 7, the cold milk and the air are mixed so as to be able to deliver and supply the foamed milk from the beverage delivery port 10. To be more specific, in the present embodiment, the air sucked from the third pump 9 is supplied into the milk supply pipe L3 via the first air supply pipe L61, the connecting part Z7, the water supply pipe L5 and the connecting part Z1, the air is appropriately mixed with the milk in the milk supply pipe L3, and is flowed through the inside of the milk supply pipe L3 so as to be able to generate the foamed milk.

### [Operation of Beverage Supply Apparatus]

Next, the operation of the beverage supply apparatus 100 according to the present embodiment will be described with reference to the drawings. The explanation will be given by assuming that, in the initial state, water is filled in a predetermined length of piping (for example, the area between the connecting part Z1 and the second switching valve V4 in the milk supply pipe L3) at least including the heating pipe L31 and the delivery pipe L32 of the milk supply pipe L3, in the water supply pipe L5, and in the drain pipe L4. Additionally, in the initial state, the first on-off valve V1, the second on-off valve V2, the third on-off valve V5, the fourth on-off valve V6, the flow rate-regulating valve V7 and the fifth on-off valve V8 are respectively in the closed state, the first switching valve V3 is in the open state to the bypass pipe L34 side, and the second switching valve V4 is in the open state to the drain pipe L4 side. Accordingly, the controller 1 executes the initial operation, in which after the water is passed through via the connecting part Z1, the first switching valve V3 and the bypass pipe L34, the first switching valve V3 is activated to make the water pass through via the inflow pipe L30, the heating pipe L31, the delivery pipe L32 and the drain pipe L4; and by doing so, the water is filled in the predetermined length of piping (the area between the connecting part Z1 and the second switching valve V4, specifically, between the connecting part Z1 and the first switching valve V3, the inflow pipe L30, the heating pipe L31, the delivery pipe L32 and the bypass pipe L34), in the water supply pipe L5, and in the drain pipe L4. In the following, for ease of explanation, the names of the valves (V1 to V8) are omitted, and only the reference numerals (V1 to V8) are indicated and explained.

The controller 1 mainly controls “beverage supply operation” for supplying the milk or foamed milk in the main body unit 2 and “water filling operation” for filling the water in the milk supply pipe L3. In the first place, in the initial state, the water is filled in the area between the connecting part Z1 and V4 in the milk supply pipe L3, the water supply pipe L5, and the drain pipe L4. In this state, V4 is open to the drain pipe L4 side, but each valve (V2, V5, V6 and V7) upstream of the piping which is filled with water is closed, and the third check valve C3 and the fourth check valve C4 are appropriately provided in the water supply pipe L5 so that the water which is filled in the milk supply pipe L3 and the like in the initial state is prevented or suppressed from being discharged from the drain pipe L4.

### [Basic Operation of Beverage Supply (Drainage Process)]

The controller 1, based on any of the supply instructions (S1-S4) from the coffee server 50, controls operation of the main body unit 2 (the cooling storage 4, the heating device 6, the pump 7 and 8, and the valves V1 to V8) to deliver and supply the hot milk, the hot foamed milk, the cold milk, or the cold foamed milk from the beverage delivery port 10 into the cup C.

Specifically, for example, when the supply instruction (S3 or S4) of the cold milk or cold foamed milk is input from the coffee server 50 to the controller 1, the controller 1, in the first place, opens V5 and V8 and drives (activates) the first pump 7 and the third pump 9. Therefore, the air delivered from the third pump 9 is supplied into the milk supply pipe L3 via the branch part Z6, V8, the connecting part Z2, V5, the connecting part Z7 and the connecting part Z1. As a result, due to this supplied air, the water between the connecting part Z1 and the connecting part Z2 in the water supply pipe L5 and the water in the milk supply pipe L3 are mainly pushed out, and is discharged as waste water to the outside (drainage tank and drainage port) via the bypass pipe L34 and drain pipe L4. In this case, the water remains as it is in the inflow pipe L30, in the heating pipe L31, and in the piping of the portion between the outlet side end part L31a and the connecting part Z8 of the delivery pipe L32. In this state, the drainage process in the basic operation of beverage supply is complete with the supply instruction S3 or S4 being input.

On the other hand, when the supply instruction (S1 or S2) of the hot milk or hot foamed milk is input to the controller 1, the controller 1, in the first place, opens V5 and V8, activates V3 to switch the flow path of the milk supply pipe L3 to the flow path via the heating pipe L31, and drives the first pump 7 and the third pump 9. Therefore, due to the air supplied in the milk supply pipe L3, the water between the connecting part Z1 and the connecting part Z2 in the water supply pipe L5 and the water in the milk supply pipe L3 are mainly pushed out, and is discharged as waste water to the outside via the inflow pipe L30, the heating pipe L31, the delivery pipe L32 and the drain pipe L4. In this case, the water remains as it is in the bypass pipe L34. In this state, the drainage process in the basic operation of beverage supply is complete with the supply instruction S1 or S2 being input.

That is, in the present embodiment, the controller 1 executes the drainage process in the basic operation of the beverage supply only for the piping through which the beverage (the milk or foamed milk) flows. In other words, the controller 1 selects the piping line for executing the drainage process in the basic operation of the beverage supply according to types, that is, the hot beverage (supply instruction S1 or S2) or the cold beverage (supply instruction S3 or S4).

Additionally, before or after this drainage process (the air purge process), the water in the bypass pipe L51 may also be discharged through the drain pipe L4 by opening V6, instead of V5, together with V8. The controller 1 closes V8, V5 or V6 when a predetermined time has passed after opening V8, V5 or V6, and stops the first pump 7 and the third pump 9 to complete the drainage process.

### [Basic Operation of Beverage Supply (Beverage Delivery Process)]

Next, the controller 1 opens V2 and activates V4 to switch the connection destination of the delivery pipe L32 to the outlet pipe L33, and then drives the first pump 7. Then, the controller 1 determines whether or not to switch the flow path of the milk supply pipe L3 to the flow path via the heating pipe L31 or to supply the air into the milk supply pipe L3, according to the input supply instructions (S1-S4).

Specifically, when supplying cold milk (supply instruction S3), the controller 1 maintains closing of V7 without activating V3. Therefore, a predetermined amount Q1 of cold milk which is sucked from the milk tank 3 is delivered by the main body unit 2 from the beverage delivery port 10 into the cup C via the bypass pipe L34, the part between the connecting part Z8 and V4 of the delivery pipe L32, and the outlet pipe L33. In this case, the water remains as it is in the inflow pipe L30, in the heating pipe L31, and in the piping of the portion between the outlet side end part L31a and the connecting part Z8 of the delivery pipe L32.

When supplying the cold foamed milk (supply instruction S4), the controller 1 opens V7 at an appropriate opening degree, and drives the third pump 9. Therefore, the main body unit 2 mixes the cold milk with the air in the milk supply pipe L3 to generate a predetermined amount Q2 of the cold foamed milk, and supplies this predetermined amount Q2 of the cold foamed milk as it is from the beverage delivery port 10 into the cup C, via the bypass pipe L34, the part between the connecting part Z8 and V4 of the delivery pipe L32 and the outlet pipe L33. In this case also, the water remains as it is in the inflow pipe L30, in the heating pipe L31, and in the piping of the portion between the outlet side end part L31a and the connecting part Z8 of the delivery pipe L32.

When supplying the hot milk (supply instruction S1), the controller 1 activates V3 to switch the flow path of the milk supply pipe L3 to the flow path via the heating pipe L31. Therefore, the main body unit 2 drives the first pump 7 to cause the cold milk sucked from the milk tank 3 to flow through the inflow pipe L30, the heating pipe L31 heated by the heating device 6, and the delivery pipe L32 so as to deliver and supply a predetermined amount Q1 of hot milk from the beverage delivery port 10 into the cup C. In this case, the water remains as it is in the bypass pipe L34.

When supplying the hot foamed milk (supply instruction S2), the controller 1 activates V3 to switch the flow path of the milk supply pipe L3 to the flow path via the heating pipe L31, opens V7 at an appropriate opening degree, and drives the third pump 9. Therefore, the main body unit 2 causes the cold foamed milk generated by mixing the cold milk with the air in the milk supply pipe L3 to flow through the heating pipe L31, so as to supply the predetermined amount Q2 of hot foamed milk from the beverage delivery port 10 into the cup C. In this case also, the water remains as it is in the bypass pipe L34.

Here, the delivery volume (suction volume) Qm of milk provided by the first pump 7 is monitored in the controller 1 based on the pulse signal which is input from the milk flowmeter 13 to the controller 1. For example, in the case of supplying a predetermined amount Q1 of milk into the cup C (supply instruction S1 or S3), in the present embodiment, the controller 1, for example, stops the first pump 7 and closes V2 when the delivery volume Qm of the milk which has been monitored reaches the predetermined amount Q1. In this state, the volume (Q1-Qx) of milk, which subtracts the volume Qx in the milk supply pipe L3 from the predetermined amount Q1, is only supplied into the cup C, and the volume of milk in the cup C does not reach the predetermined amount Q1. For this reason, after the controller 1 stops the first pump 7 and closes V2, the controller 1, for example, opens V8 and V5 in the case of the supply instruction S1 or S3 (in the case of the supply instruction S1, V3 is further activated to switch the flow path of the milk supply pipe L3 to the flow path via the heating pipe L31), and drives the third pump 9 and the first pump 7 so that the milk remained in the milk supply pipe L3 is pushed out by the air to supply the predetermined amount Q1 of milk into the cup C.

Additionally, for example, in the case of supplying a predetermined amount Q2 of the foamed milk into the cup C (supply instruction S2 or S4), in the present embodiment, when the delivery volume Qm of the milk which has been monitored reaches the predetermined amount Qc corresponding to the predetermined amount Q2 of the foamed milk which is determined in advance, the controller 1 stops the first pump 7 and closes V2, for example. In this state, the volume (Q2-Qx) of milk, which subtracts the volume Qx in the milk supply pipe L3 from the predetermined amount Q2, is only supplied into the cup C, and the volume of the foamed milk in the cup C does not reach the predetermined amount Q2. For this reason, after the controller 1 stops the first pump 7 and closes V2, the controller 1, for example, opens V8 and V5 in the case of the supply instruction S2 or S4 (in the case of the supply instruction S2, V3 is further activated to switch the flow path of the milk supply pipe L3 to the flow path via the heating pipe L31), and drives the third pump 9 and the first pump 7 so that the foamed milk and milk remained in the milk supply pipe L3 may be pushed out by the air to supply the predetermined amount Q2 of the foamed milk into the cup C.

Then, when a predetermined time has passed after opening V8 and V5, the controller 1 closes V8 and V5, brings back the connection destination of the delivery pipe L32 switched by V4 to the drain pipe L4 side, and stops the first pump 7 and the third pump 9 to complete the beverage delivery process. Then, the controller 1 proceeds to the next water filling operation.

### [Basic Operation of Water Filling Operation (Water Filling Process)]

When supplying the predetermined amount Q1 of milk or the predetermined amount Q2 of the foamed milk is complete, the controller 1, as in the initial state, controls operation of each valve (V1 to V8) and each pump (7 to 9) to fill water in a predetermined length of piping (for example, the area between the connecting part Z1 and V4 in the milk supply pipe L3) at least including the heating pipe L31 and the delivery pipe L32 of the milk supply pipe L3, in the water supply pipe L5, and in the drain pipe L4.

Specifically, when the beverage delivery process is complete, the control valve 1, for example, opens V5 and drives the first pump 7 and the second pump 8. Therefore, water supplied by the second pump 8 is supplied from a predetermined part (connecting part Z1 in the present embodiment) between the first pump 7 and milk tank 3 in the milk supply pipe L3 into the milk supply pipe L3 through the water supply pipe L5. Then, when a predetermined time has passed after driving the first pump 7 and the second pump 8, the controller 1 stops the first pump 7 and the second pump 8, and closes V5. As a result, as in the initial state, the beverage supply apparatus 100 fills water in the area between the connecting part Z1 and V4 in the milk supply pipe L3, in the water supply pipe L5 and in the drain pipe L4, and enters into the standby state.

More specifically, when the beverage delivery process by the supply instruction S1 or S2 is complete, water remains in the bypass pipe L34. Accordingly, by filling water in the area between the connecting part Z1 and V3, the inflow pipe L30, the heating pipe L31 and the delivery pipe L32 in the predetermined length of piping, water is filled in a predetermined length of piping as in the initial state. Thus, the water filling process after the completion of the beverage delivery process by the supply instruction S1 or S2 is complete. Additionally, when the beverage delivery process by the supply instruction S3 or S4 is complete, water remains in the inflow pipe L30, in the heating pipe L31, and in the piping of the portion between the outlet side end part L31a and the connecting part Z8 of the delivery pipe L32. Accordingly, by filling water in the bypass pipe L34, water is filled in the predetermined length of piping as in the initial state. Thus, the water filling process after the beverage delivery process by the supply instruction S3 or S4 is complete. That is, in the present embodiment, water is refilled only for the piping line of the milk supply pipe L3 through which the milk or foamed milk has flowed.

In the state in which the air is supplied into the milk supply pipe L3 by the beverage delivery process to push the milk or foamed milk out from the inside of the milk supply pipe L3, the milk or foamed milk may not be completely removed from the inside of the milk supply pipe L3. For this reason, in this state, when the basic operation (water filling process) of the water filling operation is executed to fill water in the milk supply pipe L3, the milk supply pipe L3, to be exact, may be filled with dilute watery milk solution. Here, the heating pipe L31 is heated to high temperature by the heating device 6, and thus, even if assuming that germs such as microbes are mixed in the dilute watery milk solution, germs such as microbes will not grow in the high-temperature heating pipe L31. On the other hand, in the standby state of the beverage supply apparatus 100 after the completion of the beverage delivery process by the supply instruction S1 or S2, the temperature of the dilute watery milk solution, in particular, in the piping of the portion distant from the outlet side end part L31a of the heating pipe L31 in the delivery pipe L32 may be a temperature at which germs such as microbes are likely to grow due to nutrients such as proteins and the like (for example, about 30° C.). Additionally, although the temperature in the bypass pipe L34 in the standby state after the completion of the beverage delivery process by the supply instruction S3 or S4, and the temperature in the piping of the portion distant from the inlet side end part L31b of the heating pipe L31 in the inflow pipe L30 in the standby state after the completion of the beverage delivery process by the supply instruction S1 or S2 are lower than the temperature in the delivery pipe L32, germs such as microbes may grow in these temperatures.

### [Water Refilling Operation in Standby State]

The structure for preventing the growth of germs in the inflow pipe L30, the delivery pipe L32 and the bypass pipe L34 in the standby state after the completion of the beverage delivery process will now be explained. In the present embodiment, when the standby state continues for a predetermined time, the controller 1 executes a water refilling operation which discharges water inside the predetermined length of piping through the drain pipe L4, and then fills water in the predetermined length of piping again.

Specifically, the controller 1 fills water in the predetermined length of piping at least including the heating pipe L31 and the delivery pipe L32 of the milk supply pipe L3 (for example, the area between the connecting part Z1 and V4 in the milk supply pipe L3, specifically, the area between the connecting part Z1 and V3, the inflow pipe L30, the heating pipe L31, the delivery pipe L32, and the bypass pipe L34), in the water supply pipe L5, and in the drain pipe L4, and if the standby state continues for a predetermined time without input of any of the supply instructions (S1-S4), the drainage process is executed first. The drainage process in this water refilling operation is, for example, executed for the predetermined length of piping, the water supply pipe L5 and the drain pipe L4 so that water filled in these pipings is discharged. The controller 1, when this drainage process is complete, executes the water filling process. The water filling process in this water refilling operation is executed for the piping to which the drainage process is executed, and therefore, water is filled in all of these pipings again. Therefore, water is filled again in the predetermined length of piping at least including the heating pipe L31 and the delivery pipe L32 of the milk supply pipe L3, in the water supply pipe L5, and in the drain pipe L4. Then, the water refilling operation by the controller 1 is complete.

The water refilling operation may be executed, after the completion of the beverage delivery process by the supply instruction S1 or S2, in the area between the connecting part Z1 and V3, the inflow pipe L30, the heating pipe L31, the delivery pipe L32, the water supply pipe L5, and the drain pipe L4; and may be executed, after the completion of the beverage delivery process by the supply instruction S3 or S4, in the area between the connecting part Z1 and V3, the bypass pipe L34, the area between the connecting part Z8 and V4 in the delivery pipe L32, the water supply pipe L5, and the drain pipe L4. In this case, as for the duration of the standby state, the duration of the standby state in which the supply instruction S1 or S2 is not input, and the duration of the standby state in which the supply instruction S3 or S4 is not input, are separately counted so as to execute different water refilling operations.

Additionally, as described above, if the duration of the standby state is separately counted in the case of a hot beverage (supply instruction S1 or S2) and in the case of a cold beverage (supply instruction S3 or S4) to execute different water refilling operations, as for the threshold of the duration of the standby state (the predetermined time) for practicing the refilling operation, the threshold in the case of a hot beverage is preferably greater (longer) than the threshold in the case of a cold beverage, for example. Specifically, in the standby state, the temperature of the water in the piping for hot beverage is higher than that of the water in the piping for cold beverage, and thus, the possibility of germs such as microbes grow in the piping for a hot beverage is higher than that of the piping for a cold beverage. For this reason, it is better that the threshold for a hot beverage is longer than the threshold for a cold beverage. Therefore, the number of times of water filling operation in the piping for cold beverage can be reduced to the minimum necessary, and the amount of waste water can be reduced.

### [Rinsing Process]

Additionally, in the present embodiment, the controller 1 executes the rinsing process in the milk supply pipe L3 before the water filling process.

Specifically, when the supplying of the predetermined amount of milk or foamed milk is complete, the controller 1 executes the rinsing process which causes water from the predetermined part between the first pump 7 and the milk tank 3 in the milk supply pipe L3 to flow through to the milk supply pipe L3 so as to rinse the inside of the milk supply pipe L3, and discharges the rinse water through the drain pipe L4. The controller 1 then executes the water filling process for filling water in the predetermined length of piping.

To be more specific, when the beverage delivery process is complete, the controller 1, for example, opens V5, appropriately activates V3, and drives the first pump 7 and the second pump 8. Therefore, water supplied by the second pump 8 is supplied from the predetermined part between the first pump 7 and the milk tank 3 in the milk supply pipe L3 (connecting part Z1 in the present embodiment) to the inside of the milk supply pipe L3 through the water supply pipe L5. As a result, the water in the water supply pipe L5, the water in the area between the connecting part Z1 and V4 in the milk supply pipe L3, and the water in the drain pipe L4 are pushed out by the water supplied by the second pump 8 and discharged through the drain pipe L4. As for rinsing of the piping between V3 and V4 in the milk supply pipe L3, specifically, only the piping through which the milk or foamed milk has been flowed by the beverage delivery process is executed. That is, after the supply instruction S3 or S4, the water is flowed via the bypass pipe L34, and after the supply instruction S1 or S2, the water is flowed via the heating pipe L31. For example, during a predetermined time which is set to be able to sufficiently rinse and clean the inside of the water supply pipe L5, the area between the connecting part Z1 and V4 in the milk supply pipe L3, and the drain pipe L4, the controller 1 drives the first pump 7 and the second pump 8, and after the elapse of such predetermined time, stops the first pump 7 and the second pump 8 and closes V5. Thus, the controller 1 executes the rinsing process for rinsing and cleaning the inside of the piping before the water filling process.

The controller 1 controls water to flow through the milk supply pipe L3 for a predetermined time in the rinsing process; however, the controller 1 is not limited to this and may also control the predetermined amount of water to flow through the milk supply pipe L3 in the rinsing process. In this case, the controller 1 controls operation of the first pump 7, the second pump 8 and V5 based on the pulse signal from the water flowmeter 16.

According to the beverage supply apparatus 100 of the present embodiment, when the standby state continues for a predetermined time, water inside the predetermined length of piping including at least the heating pipe L31 heated by the heating device 6 and the delivery pipe L32 in the milk supply pipe L3 is discharged through the drain pipe L4, and then, the predetermined length of piping is filled with water again. That is, when the standby state continues for a long time, the water inside the predetermined length of piping is replaced. Therefore, in the standby state after the completion of the beverage delivery process, even when the temperature in the delivery pipe L32 reaches the temperature where germs such as microbes are likely to grow, water in the predetermined length of piping including the delivery pipe L32 after the completion of the beverage delivery process can be replaced at appropriate time intervals, and thus, in the standby state, while preventing the milk constituent to be precipitated and solidified, growth of germs in the heating pipe L31 and the delivery pipe L32 in the standby state after the completion of the beverage delivery process can be prevented. Thus, the beverage supply apparatus 100 capable of supplying high quality beverage with further improved safety and sanitation can be provided.

Additionally, in the present embodiment, in the standby state after the completion of the beverage delivery process, water in the bypass pipe L34 can also be replaced by the water refilling process. Thus, in the standby state after the completion of the beverage delivery process, the growth of germs in the bypass pipe L34 can also be prevented.

Also, when the standby state continues for a long time, water filled in the piping by the water filling process is gradually discharged from the drain pipe L4, and the air layer (air sump) may be generated in the upper area in the heating pipe L31. With regard to this, in the beverage supply apparatus 100 of the present embodiment, the precipitation and solidification of the milk constituent due to generation of the air layer can be more securely prevented by automatically refilling water at a predetermined timing before the standby state continues for a long time and the air layer is generated in the upper area in the heating pipe L31.

Further, in the present embodiment, the heating device 6 heats the heating pipe L31 to maintain the predetermined heating set temperature in the state in which any of the supply instructions (S1-S4) for milk or foamed milk is input, or in the standby state in which none of the supply instructions (S1-S4) is input in the controller 1. Therefore, the breeding of germs in the standby state can be more effectively prevented or suppressed, and when the supply instruction (S1 or S2) of hot milk or foamed milk is input, the hot milk or foamed milk can be promptly supplied without having to wait for temperature increase of the heating pipe L31.

Also, in the present embodiment, the heating set temperature of the heating device 6 in the standby state is set to be higher than the heating set temperature of the heating device 6 in the state in which the supply instruction (S1 or S2) for hot milk or hot foamed milk is input. For example, the relatively low temperature water flows through the heating pipe L31 in the water refilling operation or the rinsing process to lower the temperature of the heating pipe L31. However, in the present embodiment, the heating set temperature in the standby state is set to 80° C. which is higher than 75° C. which can hot milk or foamed milk to a temperature adequate for drinking. Thus, the time (period) required for the heating pipe L31 in the standby state to be the temperature below the temperature that can heat the hot beverage to the temperature adequate for drinking by causing water to flow through in the water refilling operation or the rinsing process, for example, can be shortened. As a result, when the supply instruction of hot beverage is input, the hot milk or foamed milk can be promptly supplied without having to wait for the temperature elevation of the heating pipe L31.

Additionally, in the present embodiment, when supply of the predetermined amount of milk or foamed milk is complete, the controller 1 executes the rinsing process which causes the water from the predetermined part between the first pump 7 and the milk tank 3 in the milk supply pipe L3 to flow through to the milk supply pipe L3 so as to rinse the inside of the milk supply pipe L3, and discharges the rinse water through the drain pipe L4, and then executes the water filling process for filling water in the predetermined length of piping. Therefore, it becomes possible to prevent or suppress the milk or foamed milk from remaining in the predetermined length of piping, and thus, the growth of germs in the milk supply pipe L3 can more securely be prevented or suppressed.

Additionally, the present embodiment accommodates the milk tank 3 in the cooling storage 4 and is capable of supplying foamed milk separately from milk. Therefore, the beverage supply apparatus 100 that can supply hot milk, hot foamed milk, cold milk and cold foamed milk can be served.

Additionally, in the present embodiment, the controller 1 executes the drainage process in the basic operation of beverage supply only for the piping through which the beverage (milk or foamed milk) flows; however, the controller 1 is not limited to this. When the supply instruction (S1 or S2) of hot beverage is input, the controller 1 may discharge not only the water in the piping for hot beverage but also the water in the piping for cold beverage, and when the supply instruction (S3 or S4) of cold beverage is input, the controller 1 may discharge not only the water inside the piping for cold beverage but also the water in the piping for hot beverage. Additionally, in the present embodiment, the controller 1 refills water only for the piping line through which the milk or foamed milk has flowed in the milk supply pipe L3 by the water filling process. However, the controller 1 is not limited to this and may refill water in the overall milk supply pipe L3. For example, after the beverage delivery process by the supply instruction (S1 or S2) for a hot beverage, water is filled in the empty piping for a hot beverage and the water which has already been filled in the piping for cold beverage is replaced with new water, and after the beverage delivery process by the supply instruction (S3 or S4) for a cold beverage, the water which has already been filled in the piping for hot beverage is replaced with new water, and water is filled in the empty piping for cold beverage.

Next, the beverage supply apparatus 100 of the second embodiment will now be explained. In the first embodiment, the controller 1 executes the water refilling process, and prevents or suppresses the growth of germs such as microbes in the milk supply pipe L3. In the second embodiment, the controller 1 does not execute the water refilling process but executes contamination prevention operation which will be described below. In the following, only the configuration different from the first embodiment will be explained, and the explanation of the same configuration as the first embodiment will be omitted.

Here, the controller 1 in the second embodiment does not execute the water refilling process, and thus, the standby state continues for a long time, and germs such as microbes may grow in water in the delivery pipe L32. In this state, even if the supply instruction S1 or S2 is input and the water inside the predetermined length of piping is discharged from the drain pipe L4 via the heating pipe L31 and the delivery pipe L32 by the drainage process, germs may remain the inside of these pipings. In this case, as for the milk or foamed milk which is heated by flowing through the heating pipe L31 and the like, the first predetermined amount of milk or foamed milk that first passes through the delivery pipe L32, may be mixed with the remaining germs in the delivery pipe L32. Additionally, when the supply instruction S3 or S4 is input and the drainage process is executed, the germs may remain in the bypass pipe L34, and thus, the same problem exists. In order to address these problems, in the second embodiment, the controller 1 executes the contamination prevention operation, which will be described below.

### [Contamination Prevention Operation in Beverage Delivery Process]

In the second embodiment, when any of the supply instructions (S1-S4) is input during the standby state, the controller 1 discharges the water inside the predetermined length of piping through the drain pipe L4 (the drainage process), and executes the contamination prevention operation for discharging the milk or foamed milk from the drain pipe L4 by a predetermined amount, and then the milk or foamed milk is delivered from the beverage delivery port 10 through the outlet pipe L33. That is, when any of the supply instructions (S1-S4) is input in the state in which the water is filled in the predetermined length of piping, only the water inside the predetermined length of piping and the first predetermined amount of the milk or foamed milk are discharged from the drain pipe L4, and then the milk or foamed milk is delivered from the beverage delivery port 10 via the outlet pipe L33.

Specifically, when any of the supply instructions (S1-S4) is input during the standby state, the controller 1 executes and completes the drainage process according to the type of supply instruction. Then, the controller 1 starts the beverage delivery process. In the beverage delivery process in the first embodiment, the controller 1 activates V4 simultaneously with the start of the beverage delivery process to switch the connection destination of the delivery pipe L32 to the outlet pipe L33. On the other hand, in the beverage delivery process in the second embodiment, the controller 1 activates V4 after a predetermined time has passed from the start of beverage delivery process. That is, in the second embodiment, activation timing of V4 in the beverage delivery process is delayed. Therefore, during the period from the start of the beverage delivery process to the activation of V4, even if germs grow in the piping such as the delivery pipe L32 in the standby state, the first predetermined amount of milk or foamed milk which may include germs is discharged through the drain pipe L4. Then, the controller 1 activates V4, and supplies the milk or foamed milk in the cup C through the outlet pipe L33.

The controller 1 activates V4 after the predetermined time has passed from the start of beverage delivery process to discharge the first predetermined amount of milk or foamed milk; however, the controller 1 is not limited to this, and can discharge the first predetermined amount of milk or foamed milk by activating V4 at a timing based on the pulse signal from milk flowmeter 13 after the start of the beverage delivery process.

As described, in the beverage supply apparatus 100 of the second embodiment, the first predetermined amount of milk or foamed milk that first passes the delivery pipe L32 is discharged through the drain pipe L4, and is not delivered from the beverage delivery port 10. Thus, according to the beverage supply apparatus 100, even if the standby state continues for a long time, and even if germs grow in the piping such as in the delivery pipe L32, the milk or foamed milk can be supplied without germs mixed in the milk or foamed milk. Additionally, in the beverage supply apparatus 100 of the second embodiment also, water is filled at least in the predetermined length of piping in the standby state, and thus, it can prevent the beverage constituent from being precipitated and solidified inside the piping. Thus, the beverage supply apparatus 100 capable of supplying the high-quality beverage with further increase in safety from the sanitation aspect can be provided.

Additionally, the beverage supply apparatus 100 of the second embodiment can prevent a trace amount of water which could not be completely removed from the inside of the milk supply pipe L3 by the drainage process to be mixed in the milk or foamed milk and supplied into the cup C. Therefore, more high-quality milk or foamed milk can be supplied without being diluted with water.

The controller 1, in order to further improve safety in sanitation, executes the water refilling process and the rinsing process in the first embodiment, and executes the contamination prevention operation and the rinsing process in the second embodiment. However, the controller 1 is not limited to these embodiments and can execute the water refilling process, the contamination prevention operation, and the rinsing process.

Additionally, in the above embodiments, the controller 1 executes the water filling process soon after the rinsing process is complete; however, the controller 1 is not limited to this, and can execute the drainage process (the air purge process) between the rinsing process and the water filling process. Therefore, the water filling process can be performed in the state in which inside the milk supply pipe L3 becomes cleaner by pushing out the rinse water in the milk supply pipe L3 by air after the rinsing process.

Additionally, in the above embodiments, the internal piping portion in the milk supply pipe L3 is also the area to be rinsed in the rinsing process; however, the area to be rinsed is not limited to this, and the area to be rinsed can only be the external piping portion of the milk supply pipe L3. In this case, in the rinsing process, the controller 1 opens V6 instead of V5. Therefore, the drainage quantity of the rinse water can be reduced. In the above embodiments, the bypass pipe L51 is provided; however, the bypass pipe L51 may not be provided. In this case, it is better that one end of the second air supply pipe L62 is connected to the branch part Z6 and the other end is connected to the predetermined part between the second check valve C2 and the connecting part Z7 in the water supply pipe L5.

Additionally, in the above embodiments, the beverage supply apparatus 100 can supply the hot beverage (milk or foamed milk) and the cold beverage (milk or foamed milk); however, the beverage supply apparatus 100 is not limited to this, and can supply only the hot or cold beverage. Germs such as microbes are likely to grow in the delivery pipe L32, which is connected to the heating pipe L31, and thus, the beverage supply apparatus 100 is suitable for supplying the hot beverage. The bypass pipe L34 is unnecessary if a cold beverage is not supplied.

Additionally, in the above embodiments, the beverage supply apparatus 100 can selectively supply milk or foamed milk; however, the beverage supply apparatus 100 is not limited to this and may continuously supply milk and foamed milk, may supply milk only, or may supply foamed milk only in response to one supply instruction. Additionally, any appropriate beverage other than milk may be supplied. Additionally, the beverage supply apparatus 100 is provided adjacent to the coffee server 50; however, the beverage supply apparatus 100 is not limited to this, and the entirety or a part of the beverage supply apparatus 100 may be incorporated in the coffee server 50. Furthermore, the beverage supply apparatus 100 is used as the optional apparatus of the coffee server 50; however, the beverage supply apparatus 100 is not limited to this and may be used as the optional apparatus of the appropriate beverage supply apparatus or may be used as the apparatus which can independently supply the beverage.

The preferred embodiments of the present invention have been described; however, the present invention is not limited to these embodiments, and they can be variously modified and altered based on the technical idea of the present invention.

### REFERENCE SYMBOL LIST

3 Milk tank (Tank)
4 Cooling storage
6 Heating device
7 First pump (Pump)
10 Beverage delivery port
100 Beverage supply apparatus
L3 Milk supply pipe (Flow pipe)
L31 Intermediate pipe (Heating pipe)
L32 Delivery pipe
L33 Outlet pipe
L4 Drain pipe
V4 Second switching valve V4 (Switching valve)

1. A beverage supply apparatus comprising a tank for storing a beverage; a heating device for heating an intermediate pipe which constitutes a part of a flow pipe which connects the tank and a beverage delivery port; and a pump which is provided at a predetermined part closer to the tank than the intermediate pipe in the flow pipe,
wherein the beverage supply apparatus,
when a supply instruction for a hot beverage is input, causes the beverage which is sucked from the tank by driving the pump to flow through the intermediate pipe which is heated by the heating device and through a delivery pipe which constitutes a part of the flow pipe and is connected to an outlet side end part of the intermediate pipe, so as to deliver and supply a predetermined amount of the hot beverage from the beverage delivery port, and
when the supply of the predetermined amount of the hot beverage is complete, fills water inside a predetermined length of piping which at least includes the intermediate pipe and the delivery pipe in the flow pipe, and enters into a standby state,
wherein the beverage supply apparatus further comprises a switching valve which switches a connection destination of the delivery pipe to an outlet pipe or to a drain pipe, in which the outlet pipe is connected to the beverage delivery port, and
when the standby state continues for a predetermined time, the beverage supply apparatus discharges the water inside the predetermined length of piping through the drain pipe, and then fills water again inside the predetermined length of piping.

2. A beverage supply apparatus comprising a tank for storing a beverage; a heating device for heating an intermediate pipe which constitutes a part of a flow pipe which connects the tank and a beverage delivery port; and a pump which is provided at a predetermined part closer to the tank than the intermediate pipe in the flow pipe,
wherein the beverage supply apparatus,
when a supply instruction for a hot beverage is input, causes the beverage which is sucked from the tank by driving the pump to flow through the intermediate pipe which is heated by the heating device and through a delivery pipe which constitutes a part of the flow pipe and is connected to an outlet side end part of the intermediate pipe, so as to deliver and supply a predetermined amount of the hot beverage from the beverage delivery port, and
when the supply of the predetermined amount of the hot beverage is complete, fills water inside a predetermined length of piping which at least includes the intermediate pipe and the delivery pipe in the flow pipe, and enters into a standby state,
wherein the beverage supply apparatus further comprises a switching valve which switches a connection destination of the delivery pipe to an outlet pipe or to a drain pipe, in which the outlet pipe is connected to the beverage delivery port, and
when the supply instruction is input during the standby state, the beverage supply apparatus discharges the water inside the predetermined length of piping through the drain pipe and discharges the hot beverage from the drain pipe by a predetermined amount, and then delivers the hot beverage from the beverage delivery port through the outlet pipe.

3. The beverage supply apparatus according to claim 1, wherein the heating device heats the intermediate pipe to maintain a predetermined heating set temperature in the state in which the supply instruction is input or in the standby state.

4. The beverage supply apparatus according to claim 3, wherein the heating set temperature in the standby state is set to be higher than the heating set temperature in the state in which the supply instruction is input.

5. The beverage supply apparatus according to claim 1, wherein when the supply of the predetermined amount of the beverage is complete, water is flowed for a predetermined time from a predetermined part between the pump and the tank in the flow pipe to the inside of the flow pipe to rinse the inside of the flow pipe and discharge the rinse water through the drain pipe, and then water is filled in the predetermined length of piping.

6. The beverage supply apparatus according to claim 1, wherein the liquid milk is held in the tank, and by supplying air from a predetermined part between the pump and the tank in the flow pipe to the inside of the flow pipe and by driving the pump, the liquid milk and the air are mixed so that foamed milk is delivered and supplied from the beverage delivery port.
